(19) United States
(12) Patent Application Publication
(10) Pub. No.: US 2008/0240342 A1
(43) Pub. Date: Oct. 2, 2008

(54) Advanced Csct Detector Shapes

(75) Inventors: Axel Thran, Hamburg (DE); Jens-Peter Schlomka, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,417

(22) PCT Filed: Oct. 6, 2006
(86) PCT No.: PCT/IB06/53657

§ 371 Date: Apr. 16, 2008

(30) Foreign Application Priority Data
Oct. 20, 2005 (EP) 05109804.4

(51) Int. Cl. G01N 23/00

(52) U.S. Cl. 378/19

(57) ABSTRACT

The application of CSCT to baggage inspection necessitates a large field of view, resulting in a large gantry that has to sustain large centrifugal forces. Accordingly, various CSCT geometries are described which enable smaller gantry sizes. In particular, a CSCT scanner comprising a detector unit that is not focus-centred is described.

The invention relates to the field of tomographic imaging. In particular, the invention relates to a coherent scatter computed tomography apparatus for examination of an object of interest, to a detector unit, an image processing device, a method of examination of an object of interest, a computer-readable medium and a program element.

Coherent scatter computed tomography (CSCT) is a novel imaging technique based on coherently scattered x-ray photons. CSCT yields scatter properties of each point of the investigated cross-sectional area in the object of interest. The CSCT set up is similar to a single slice CT with additional detector rows to measure radiation scattered out of the fan plane.

In CSCT, a collimated fan-beam of small divergence out of the fan plane exposes an object of interest. Both signals, the intensity of the transmitted radiation and the intensity of the scatter radiation caused by scatter processes within the object, are measured by a detector for transmitted radiation located in the fan plane and a detector for scattered radiation arranged parallel to the fan plane. The application of CSCT in baggage inspection necessitates a large field of view. On the other hand, a small gantry size may be advantageous not only to save space for the scanner but also because smaller diameters may decrease the centrifugal forces in the rotating gantry and a small distance between x-ray source and detector may increase the detected photon flux.

Therefore, it may be desirable to have a smaller gantry of a CSCT scanner.

According to a first aspect of the invention, a coherent scatter computed tomography apparatus for examination of an object of interest may be provided, the coherent scatter computed tomography apparatus comprising an electromagnetic radiation source adapted for emitting electromagnetic radiation to an object of interest from a focal spot, a scatter detector, a first detector element of the scatter detector and being arranged at a first distance from the focal spot and adapted for detecting first scattered electromagnetic radiation from the object of interest, and a second detector element of the scatter detector and being arranged at a second distance from the focal spot and adapted for detecting second scattered electromagnetic radiation from the object of interest, wherein a first length of the first distance projected onto a fan plane is different from a second length of the second distance projected onto the fan plane.

Therefore, a CSCT apparatus may be provided having a detector with an improved geometry that may allow for a smaller size of the gantry than current focus-centred geometries.

According to an embodiment of the invention, the CSCT apparatus may further comprise a collimator arranged between the electromagnetic radiation source and the object of interest, wherein the collimator is adapted for collimating an electromagnetic radiation beam emitted by the electromagnetic radiation source to form a fan-beam.

According to another embodiment of the invention, the CSCT apparatus may further comprise a second collimator arranged between object of interest and the detecting elements, wherein the collimator is adapted for collimating electromagnetic radiation scattered in the object of interest towards the scatter detector

The detector elements may be arranged on a detector unit that may or may not have a circular cross-sectional shape with respect to the fan plane. Therefore, the collimators in front of the detector elements may not be required to be perpendicular to the detector surface.

According to another embodiment of the invention, the coherent scatter computed tomography apparatus further comprises a detector unit with a first detector sub-unit and a second detector sub-unit, wherein the first detector element is part of the first detector sub-unit and wherein the second detector element is part of the second detector sub-unit. Both, the first and the second detector sub-units are focus-centred.

For example, the second detector sub-unit is arranged nearer to the focal spot compared with the first detector sub-unit.

According to another embodiment of the invention, the first and the second detector sub-units are separated from each other.

Therefore, the main detector unit may not be one single unit but comprises several, separated sub-units, which can be arranged independently from each other, improving design freedom.

According to another embodiment of the invention, the first detector element and the second detector element have the same size.

According to another embodiment of the invention, the first detector element is part of the first detector sub-unit and the second detector element is part of the second detector sub-unit. The first detector sub-unit is focus-centred and has a first radius of curvature, wherein the second detector sub-unit has a second radius of curvature, which is half of the first radius of curvature.

In other words, a central part of the detector unit is focus-centred and at least one outer part has a curvature radius that is smaller than the source to detector distance. Furthermore, all circular arcs may form a single continuous curve.

This geometry advantageously allows for a use of detector elements of equal size along the whole detector length whilst still enabling each detector element to cover a fan angle of the same size as in the focus-centred geometry.

According to another embodiment of the invention, the first radius of curvature is twice the size of the second radius of curvature.

For example, the first radius of curvature may correspond to the source-detector distance and the second radius of curvature may correspond to half the source-detector distance.

In yet a further embodiment of the invention, the first detector element and the second detector element are part of the detector unit, wherein the detector unit has a limacon shaped cross section with respect to the fan plane.

In other words, the detector unit corresponds to a limacon geometry and may form an approximate circular arc, when projected to the fan plane, but one with a smaller radius than in the focus-centred design. Due to the limacon-like shape the measured data are, after fan beam to parallel beam rebinning, located on a plane. Therefore, the projection onto a plane virtual detector necessary for focus-centred detectors may not apply. Consequently, the evaluation of the scatter data measured with a detector of this shape may be faster and may even avoid interpolation procedures and systematic errors, which would eventually worsen the resolution of the reconstructed data.

According to another embodiment of the invention, the first detector element and the second detector element are part of the detector unit and the cross section of the detector unit with respect to the fan plane corresponds to a circular arc with a centre different to the focal spot.

According to another embodiment of the invention, the detector unit comprises a first scatter detector and a transmission detector both having the same cross-sectional shape with respect to the fan plane. It should be noted, however, that both detectors may have different cross-sectional shapes.

According to another embodiment of the invention, the detector unit further comprises a second scatter detector that is arranged below the fan plane, wherein the first scatter detector is arranged above the fan plane. The transmission detector is arranged between the first scatter detector and the second scatter detector in the fan plane.

According to another embodiment of the invention, the detector unit comprises only one half arc, i.e., it covers only one half of the angle range spanned from the field of view.

According to another embodiment of the invention, the coherent scatter computed tomography apparatus further comprises a third detector sub-unit, wherein the first detector sub-unit is arranged between the second detector sub-unit and the third detector sub-unit.

According to another embodiment of the present invention, the coherent scatter computed tomography apparatus further comprises a reconstruction unit adapted for reconstructing an image of the object of interest on the basis of the detected first and second electromagnetic radiation.

According to a further aspect of the invention, the CSCT apparatus may be applied as a baggage inspection apparatus, a medical application apparatus, a material testing apparatus or a material science analysis apparatus. In particular for baggage inspection, the defined functionality of the invention may allow a secure, reliable, highly accurate and fast analysis of a material whilst providing for a small size of the gantry.

In another embodiment, the detector unit comprises collimator lamellae that are focussed onto the x-ray focus. These collimator lamellae form a collimator that may be attached to a frame.

Furthermore, in another embodiment of the invention, the radiation source may be adapted for emitting a polychromatic radiation beam.

According to yet a further aspect of the invention, a detector unit for a coherent scatter computed tomography apparatus for examination of an object of interest is provided, the detector unit comprising a scatter detector, a first detector element of the scatter detector being arranged at a first distance from the focal spot and adapted for detecting first electromagnetic radiation from the object of interest, and a second detector element of the scatter detector being arranged at a second distance from the focal spot and adapted for detecting second electromagnetic radiation from the object of interest, wherein a first length of the first distance projected onto a fan plane is different from a second length of the second distance projected onto the fan plane.

According to this aspect of the invention, a detector unit is provided which allows for a smaller gantry size when installed in a CSCT system.

According to another aspect of the invention, an image processing device for examination of an object of interest may be provided, the image processing device comprising a memory for storing data corresponding to the detected first and second electromagnetic radiation, and a reconstruction unit adapted for reconstructing an image of the object of interest on the basis of the stored data.

Hence, an image processing device may be provided which is adapted for performing a data reconstruction on the basis of data acquired by the above-described CSCT apparatus.

According to another aspect of the invention, a method of examination of an object of interest may be provided, the method comprising the steps of emitting, by a radiation source, electromagnetic radiation to the object of interest, the emitted radiation having a focal spot, detecting, by a first detector element of a scatter detector and being arranged at a first distance from the focal spot, first electromagnetic radiation from the object of interest, and detecting, by a second detector element of the scatter detector and being arranged at a second distance from the focal spot, second electromagnetic radiation from the object of interest, wherein a first length of the first distance projected onto a fan plane is different from a second length of the second distance projected onto the fan plane.

According to another aspect of the invention, a computer-readable medium may be provided, in which a computer program for examination of an object of interest is stored which, when executed by a processor, is adapted to carry out the above-mentioned method steps.

According to another aspect of the invention, there is provided a program element for examination of an object of interest, which may be stored on the computer-readable medium. The program element may be adapted to carry out the steps of emitting electromagnetic radiation to the object of interest, detecting first radiation and second radiation by respective first and second detector elements, wherein the projection of the first distance between the first detector element and the focal spot onto the fan plane is different from the projection of the second distance between the second detector element and the focal spot onto the fan plane.

The program element may preferably be loaded into working memories of a data processor. The data processor may thus be equipped to carry out embodiments of the method aspects of the invention. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It may be seen as the gist of an exemplary embodiment of the invention, that a CSCT apparatus is provided which comprises a detector unit which is not focus-centred, but comprises detecting elements which have different distances from the focal spot of the radiation source. This may result in a smaller size of the gantry.

These and other aspects of the invention will now be described with reference to the embodiments described hereinafter.

Embodiments of the invention will now be described, with reference to the following drawings.

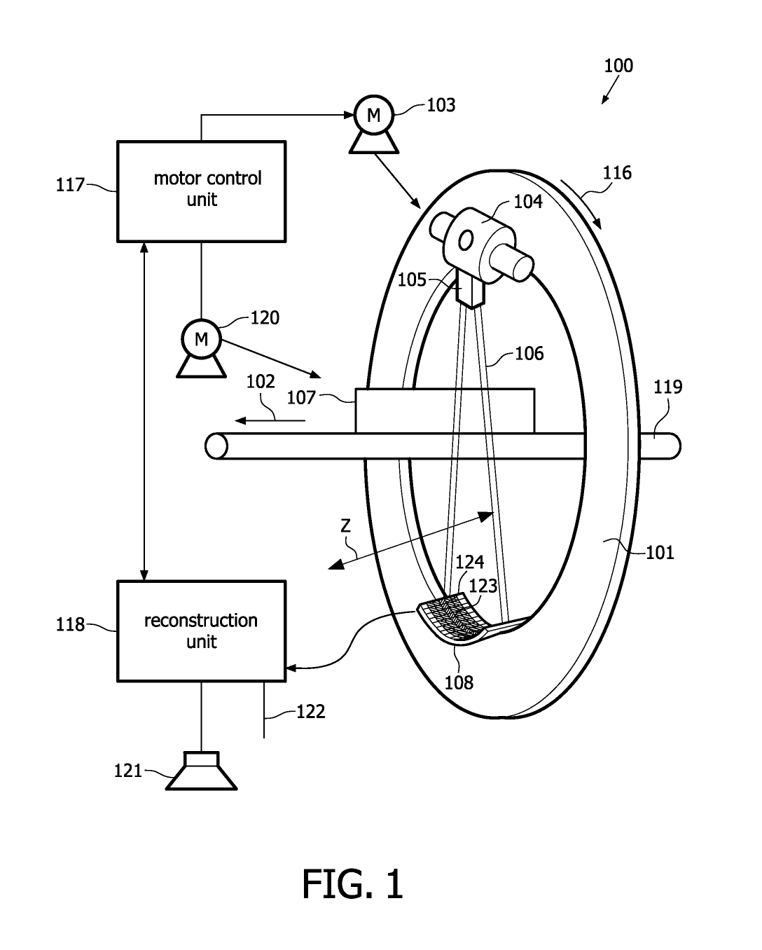

FIG. 1 shows a simplified schematic representation of an examination apparatus according to an embodiment of the invention.

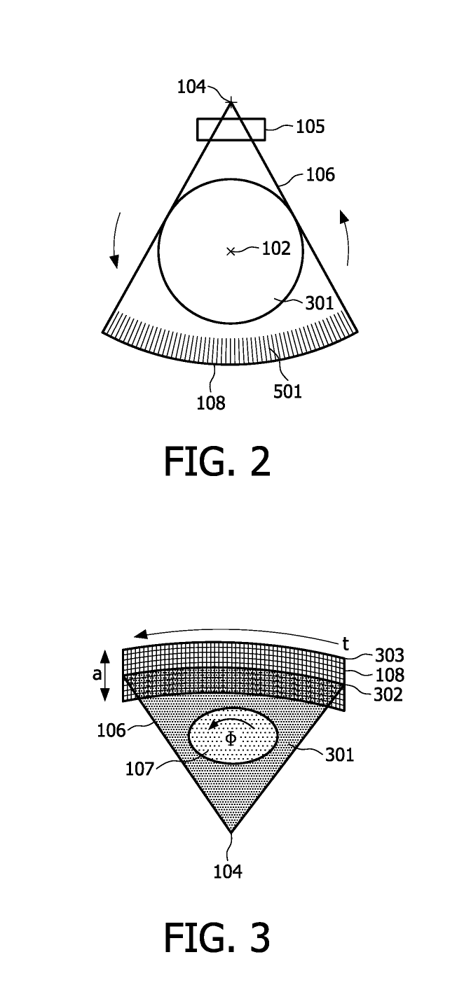

FIG. 2 shows a simplified schematic view along the z-axis of FIG. 1.

FIG. 3 shows a schematic representation of a geometry of a detector for measuring coherently scattered x-ray photons.

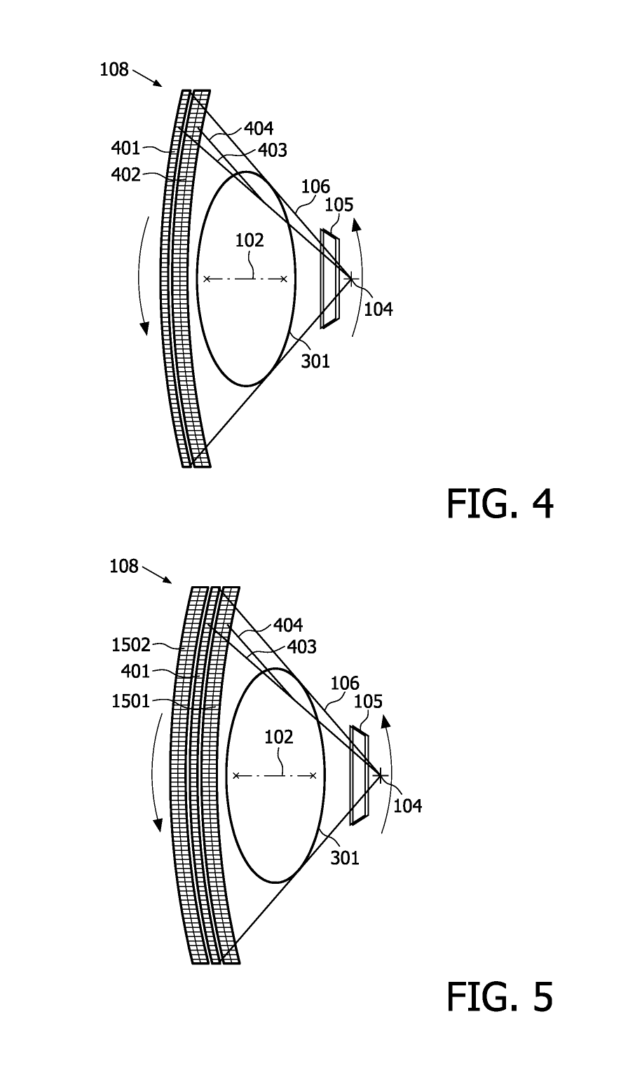

FIG. 4 shows a schematic representation of a perspective view of the basic parts of a CSCT scanner.

FIG. 5 shows an embodiment of the invention comprising two scatter detectors located on both sides of the fan plane.

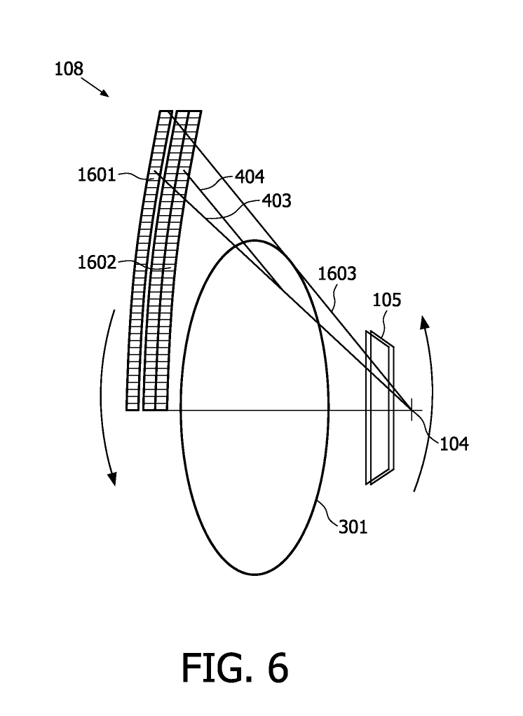

FIG. 6 shows an embodiment with detectors covering only half of the angle range spanned by the field of view.

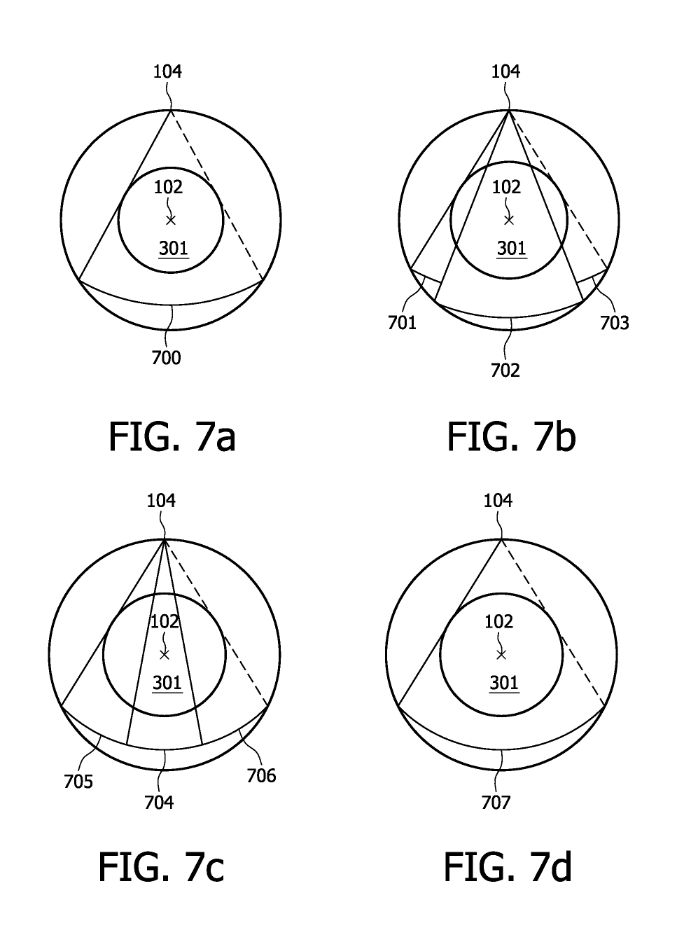

FIG. 7 shows four different detector geometries.

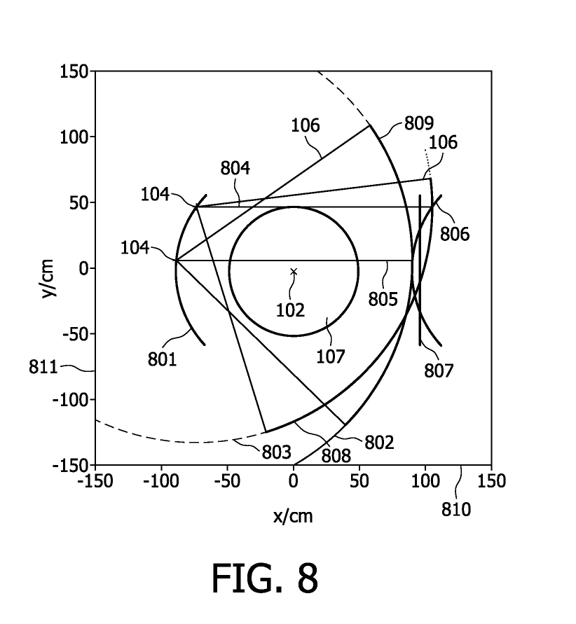

FIG. 8 shows two positions of the rotating gantry superimposed onto the fan plane.

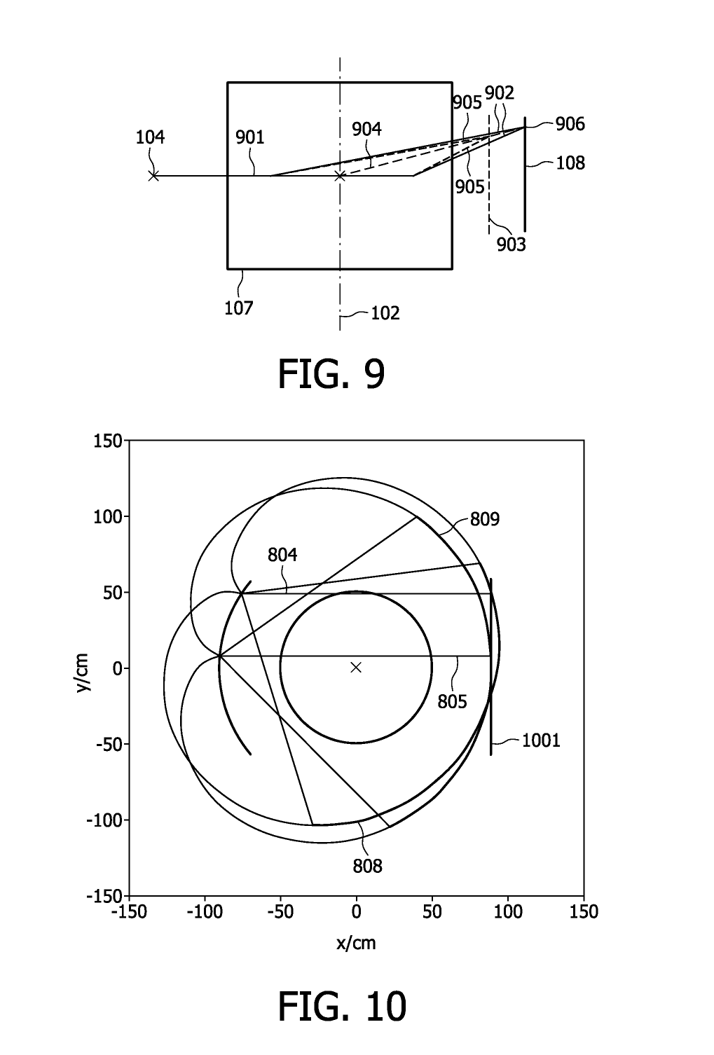

FIG. 9 shows a cross-sectional view in which two rays are scattered at different locations in the object of interest and measured in the same detector element.

FIG. 10 shows two positions of the rotating gantry superimposed onto the fan plane with a limacon-shaped detector.

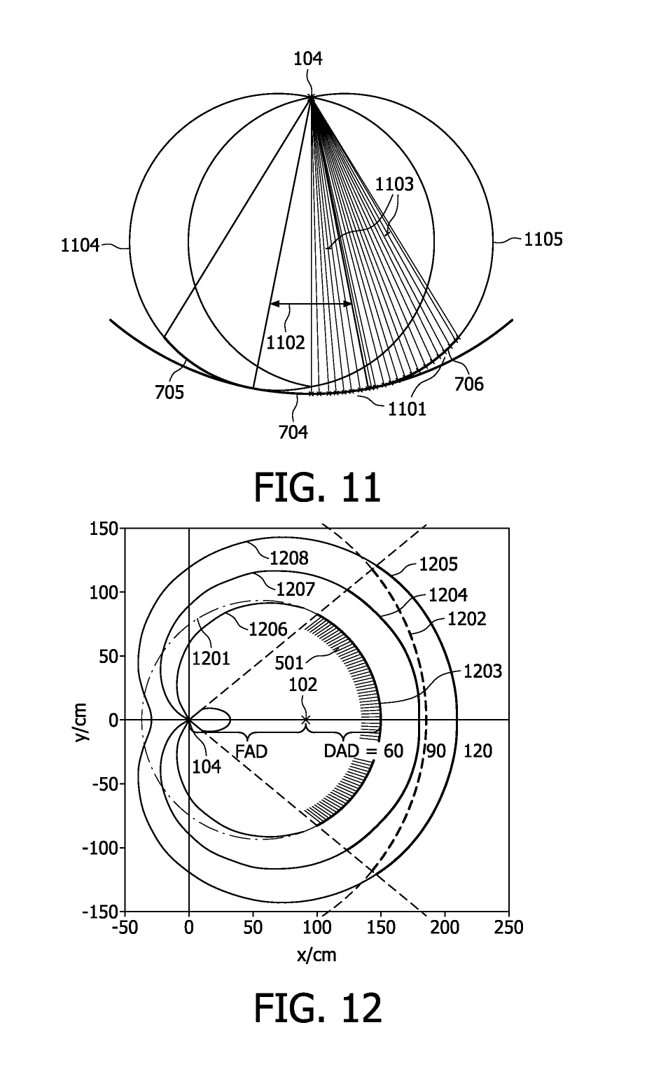

FIG. 11 shows a schematic representation of a detector shape and completed circles of its geometry.

FIG. 12 shows three example shapes of limacons and corresponding limacon shaped detectors.

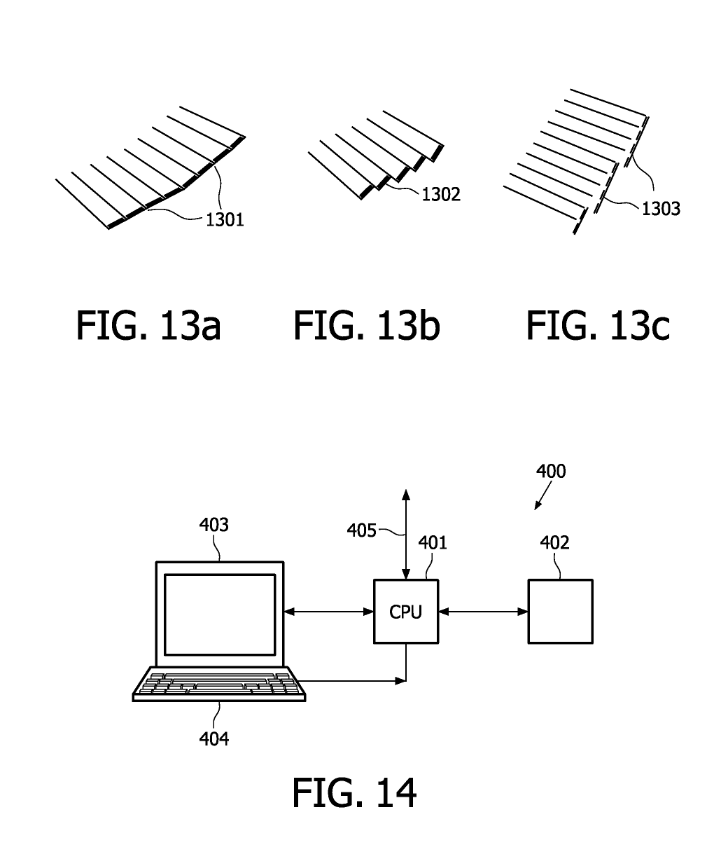

FIG. 13 shows three example arrangements of detectors and collimators according to aspects of the invention.

FIG. 14 shows an embodiment of an image processing device, for executing an embodiment of a method in accordance with the invention.

In the different drawings, similar or identical elements are provided with the same reference numerals.

FIG. 1 shows an examination apparatus according to an embodiment of the invention that is adapted as a computer tomography apparatus. This embodiment will be described for application in baggage inspection. However, it should be noted that the invention is not limited to this field of application, but may also be applied in the field of medical imaging, or other industrial applications, such as material testing.

The coherent scatter computed tomography apparatus 100 depicted in FIG. 1 is a fan-beam coherent scatter computed tomography scanner. The CSCT scanner depicted in FIG. 1 comprises a gantry 101, which is rotatable around a rotational axis 102. The gantry 101 is driven by means of a motor 103. Reference numeral 104 designates a source of radiation such as an x-ray source.

Reference numeral 105 designates an aperture system that forms the radiation beam emitted from the radiation source to a fan-shaped radiation beam 106. The fan-beam 106 is directed such that it penetrates an object of interest 107 arranged in the centre of the gantry 101, i.e. in an examination region of the CSCT scanner, and impinges onto the detector 108. As may be taken from FIG. 1, the detectors for transmitted and scattered radiation 108 are arranged on the gantry 101 opposite to the source of radiation 104, such that the surface of the detector for transmitted radiation is covered by the fan-beam 106 and the detector for scattered radiation is outside the fan beam. The detector 108, which is depicted in FIG. 1, comprises a plurality of detector elements 123 each capable of detecting, in an energy-resolving manner, X-rays or individual photons that have penetrated the object of interest 107.

During a scan of the object of interest 107, the source of radiation 104, the aperture system 105 and the detector unit 108 are rotated along the gantry 101 in the direction indicated by arrow 116. For rotation of the gantry 101 with the source of radiation 104, the aperture system 105 and the detector 108, the motor 103 is connected to a motor control unit 117, which is connected to a calculation or reconstruction unit 118.

In FIG. 1, the object of interest 107 may be an item of baggage which is disposed on a conveyor belt, or a patient on a movable table 119. During the scan of the object of interest 107, the gantry 101 rotates around the item of baggage 107. Preferably, the conveyor belt or patient table 119 stops during the scans to thereby measure single slices. The conveyor belt 119 may also displace the object of interest 107 slowly along a direction parallel to the rotational axis 102 of the gantry 101. By this, the object of interest 107 is scanned along a helical scan path.

The detector 108 may be connected to the calculation or reconstruction unit 118. The reconstruction unit 118 may receive the detection result, i.e. the read-outs from the detector elements 123 of the detector 108 and may determine a scanning result on the basis of the read-outs. Furthermore, the reconstruction unit 118 communicates with the motor control unit 117 in order to coordinate the movement of the gantry 101 with motors 103, 120 and with the conveyor belt 119.

The reconstruction unit 118 may be adapted for reconstructing an image of the object of interest 107 on the basis of the detected first and second electromagnetic scatter radiation, according to an embodiment of the present invention. A reconstructed image generated by the reconstruction unit 118 may be output to a display (not shown in FIG. 1) via an interface 122.

The reconstruction unit 118 may be realized by a data processor to process read-outs from the detector elements 123 of the detector 108.

Furthermore, as may be taken from FIG. 1, the reconstruction unit 118 may be connected to a loudspeaker 121, for example, to automatically output an alarm in case of the detection of suspicious material in the item of baggage 107.

The coherent scatter computed tomography apparatus 100 for examination of the object of interest 107 includes the detector 108 having the plurality of detecting elements 123 arranged in a matrix-like manner, each being adapted to detect x-rays. Furthermore, the computer tomography apparatus 100 comprises the determination unit or reconstruction unit 118 adapted for reconstructing an image of the object of interest 107.

The geometry of such a coherent scatter tomography apparatus as the one depicted in FIG. 1 is shown in FIGS. 2 to 5.

FIG. 2 shows a schematic representation of a coherent scatter computed tomography apparatus for measuring coherently scattered x-ray photons. In this view, parallel to the axis of rotation 102, the scatter detector and the transmission detector lie on top of each other. Other than in FIG. 4, the collimator 201 in front of the detectors 108 is shown. The detector shape is focus-centred.

In current CSCT scanners a focus-centred detector geometry is realized, i.e. all detector pixels are of the same size and have the same distance to the x-ray focus. Since the size of the gantry is mainly determined by the positions of the x-ray source and the ends of the detector banana, this rotational symmetry of the detector with respect to the focus has to be broken in order to achieve smaller gantry sizes.

As in CT, an image representing attenuation properties of the illuminated slice can be reconstructed from the measured intensities of the transmitted radiation. Likewise, from the measured intensities of scattered radiation, the differential Rayleigh scatter cross section of each point in the investigated object area can be reconstructed for a certain range of momentum transfer parameters.

Two reconstruction algorithms, the algebraic reconstruction technique (ART) and the filtered back-projection technique (FBP) are known for CT. Since ART is an iterative algorithm, the latter is much faster and usually implemented in CT scanners.

FIG. 3 shows a perspective view of a geometry of a detector for measuring coherently scattered x-ray photons. The central line 302 detects the transmitted intensity of the primary beam and the other lines, such as line 303, detect the scatter radiation.

The object 107 is placed inside the field of view 301.

FIG. 4 shows a schematic perspective view of the basic parts of a CSCT scanner according to an embodiment of the invention. Source 104 and detector 108, comprising a transmission detector 401 and a scatter detector 402, rotate around the object which has to be located in the field of view 301. The radiation beam emitted by the source 104 passes the primary collimator 105 as a fan-beam 106 and the transmitted ray 403 impinges on the transmission detector 401 and the scattered ray 404 impinges on one of the scatter detectors 402.

FIG. 5 shows a schematic perspective view of a CSCT scanner having a double scatter detector 501, 502 on either side of the fan plane according to another embodiment of the invention.

In FIG. 6, another embodiment of the invention is shown in a perspective view of a CSCT scanner having a scatter detector 402 and transmission detector 401 which cover only one half 603 of the angle range spanned from the field of view 301.

According to an embodiment of the invention, smaller gantry diameters of CSCT scanners for a given size of the field of view may be realized. In the following, three exemplary detector shapes are described which may avoid drawbacks due to the reshaping or even may have additional advantages compared to the focus-centred shape.

FIG. 7 shows three detector shapes according to exemplary embodiments of the present invention (b, c, d). (a) shows a focus-centred detector geometry.

For each shape the diameter of the field of view and the minimum distance between the field of view and the detector are set to the same values. Under these two requisites the geometry may be optimized to have a minimum gantry diameter. Of course, the diameter of real CSCT scanners with these detector shapes may be larger due to the final size of the x-ray source and of other parts, but the figures allow to compare the attainable reduction of the gantry size for the exemplary defaults.

The gantry diameters of the proposed geometries may be 9 to 13% smaller than the gantry of the focus-centred geometry (a). Besides the saving of size of the scanners, smaller gantry radiuses may also allow higher rotational speeds of the gantry for given centrifugal forces.

FIG. 7 (b) shows a detector geometry consisting of several focus-centred sections at different distances to the x-ray focus. This design may allow for a considerable smaller gantry size than known focus-centred detector shapes.

The detector design consisting of several focus-centred sections may reduce the gantry diameter by placing the outer parts of the detector 701, 703 nearer to the focal spot 104. In doing so, it may be possible to realize more than two distances between focus and individual detector sections.

The detector pixel size in each section 701-703 may have to be proportional to the distance from the focus to the detector section in order to keep the angle covered by each detector pixel constant. Within these constraints, the size of the central region 702 and the outer sections 701, 703 may be adapted to the needs of the scanner used.

FIG. 7 (c) shows a detector geometry comprising a focus-centred middle part 704 and outer parts 705, 706 having half curvature radius compared with the focus-centred middle part 704. This may reduce the costs of the detector compared to other solutions where the detector pixel pitch has to be varied in order to cover the same angle range in the fan plane.

The geometry of this detector (having a focus-centred middle part and one or two outer parts with half curvature radius) and its consequences are shown in FIG. 11. While the middle part 704 of the detector shape is still a circular arc around the focus 104, the outer parts 705, 706 coincide with circles 1104, 1105 which have a diameter equal to the focus-detector distance of the middle detector part 704. As a consequence, essential symmetry conditions of the focus-centred geometry, namely the equal size of all detector pixels and the equality of the angle ranges covered by every detector pixel, are still valid.

The size of the inner part 704 of the detector is a free parameter here. The smaller it is, the smaller may be the distance of the detector ends to the axis of rotation. On the other hand, at the detector ends the direction of incidence of the x-rays onto the detector pixels may deviate further from the surface normal, when the central region is chosen to be smaller. Crosses 1101 represent the constant pixel sizes of the pixels.

FIG. 7 (d) shows a schematic detector geometry of a limacon shaped detector. This detector geometry may provide for a simplification of the reconstruction algorithm and an improvement of the reconstructed image (additional to the smaller gantry size).

To explain this advantage compared to the current focus-centred geometry, one has to be aware of some details of the filtered back-projection technique, which is a commonly used reconstruction technique for CSCT. Such a reconstruction algorithm for coherent scatter computed tomography based on filtered back-projection is described in U. van Stevendaal et al., Med. Phys. 30(9), pp 2456-2474 (2003), to which the skilled person is referred.

In order to reconstruct the properties of the object cross-section, it may be convenient to perform a fan-beam to parallel beam rebinning of the measured data, i.e. to sort them so that data which were measured along parallel directions in the object, can be processed together. After this rebinning step, the data may have to be projected onto a virtual plane detector. In FIG. 8, this is illustrated for a focus-centred detector.

FIG. 8 shows two positions of the rotating gantry superimposed onto the fan plane. The horizontal axis 810 and the vertical axis 811 are scaled in units of cm and range from −150 cm to +150 cm.

The source 104 is rotated by 5° and 33° with respect to its left most position, respectively. Parallel rays 804, 805 measured in these projections, here two horizontal ones, hit the detector 808, 809, respectively at locations, which form a curved surface. This surface 806 is a curve in this projection onto the fan plane. After fan-beam to parallel beam rebinning, the data have to be projected from this curve surface 806 onto a plane virtual detector 807.

FIG. 9 shows, in a cross-sectional view, two rays which are scattered at different locations in the object and measured in the same detector element 906 of the detector unit 108. When the parallel rebinned data are projected onto a plane virtual detector, the original scattering angles of the rays are distorted.

One problem accompanied with this projection, namely falsification of the scattering angles, is indicated in this view perpendicular to the fan plane. This effect may lead to a systematic error in the measured scattering angles of the scanner, which may grow with larger object sizes.

Further drawbacks are the interpolations of measured data necessary in the projection step, always leading to a decrease of resolution. Furthermore, the projection onto a plane virtual detector may need valuable computational time.

Reference numeral 904 symbolizes the projection direction, reference numeral 905 symbolizes the two rays evaluated in the construction. Furthermore, reference numeral 902 symbolizes the scattered rays and 903 symbolizes the virtual detector, wherein 108 is the real detector. 901 is the primary ray.

FIG. 10 shows two positions of the rotating gantry according to FIG. 8, but with a limacon-shaped detector 808, 809. In contrast to FIG. 8, the locations where the parallel rays 804, 805 hit the detector form a plane, which is in this view onto the fan plane a straight line 1001.

In the following, the limacon shaped detector is described in more detail.

A limacon is a polar curve of the shape

r(φ)=a+b cos φ.

When FAD is the focus to axis distance and DAD is the detector to axis distance in the centre of the fan-beam, the geometrical shape of the detector (more exactly: its projection to the fan plane) has to approximate the equation

r(φ)=FAD+DAD cos φ,

within a fan angle range φ=[−φ₀,+φ₀] where r(φ) is the distance from the focal spot to the detector. The three-dimensional shape of the detector is the limacon-arc extruded in the direction perpendicular to the fan plane.

In FIG. 12, three example shapes of the detector 1203, 1204, 1205 are shown. Furthermore, the corresponding shapes of limacons 1206, 1207, 1208 are shown. For comparison, the focus-centred shape 1202 is also shown. In the limited fan angle range, the shape of a limacon can be approximated by a circular arc with a radius

$$r = \frac{{( F A D + D A D )}^{2}}{2 F A D + D A D} .$$

104 shows the position of the focal spot and 102 shows the position of the axis of rotation.

The three limacon-shaped detectors 1203, 1204, 1205 cover a fan angle range of +/−40° (FAD=90 cm, DAD=60, 90 and 120 cm). In the DAD=60 cm case, collimators 201 are plotted and a circle 1201 approximating the limacon shape according to the last equation is drawn.

The detector units according to embodiments of the invention deviate from the focus-centred detector geometry and therefore allow for a smaller gantry size.

The specifications given above refer to both the scatter detectors and to the transmission detector, because the gantry size may only be reduced if the shapes of both detectors are modified. This does not necessarily mean that both transmission detector and scatter detector must have exactly the same shape when projected onto the fan plane. Other than shown in FIG. 4, two scatter detectors may be implemented above and below the fan plane to reduce the measurement time. Furthermore, contrarily, just one half arc of the transmission and scatter detector may be implemented to save costs for the detector. The skilled person will readily appreciate that the detector shapes described above may also be applied to these alternative designs.

The limacon configuration may eliminate a calculation step necessary for the reconstruction of the measured data. In particular, a projection of rearranged measured data onto a plane virtual detector may not be necessary, as the limacon shape of the detector may render/transform the measured data to be located on such a virtual plane automatically.

Therefore, the computing time necessary for this step may be avoided. Furthermore, a falsification of the scatter angles caused by the projection step, which results in a poorer resolution of the measured scatter properties of the object, may also be avoided.

FIG. 13 shows three arrangements of detector elements and collimators approximating the described geometries where, deviating from the focus-centred geometry, the lamellae of the collimator are not always perpendicular to the detector surface. The embodiment depicted in FIG. 13 (a) shows detector modules 1301, the embodiment depicted in FIG. 13 (b) shows single detectors 1302, and the embodiment depicted in FIG. 13 (c) shows again detector modules 1303, which are separated from each other.

Like a focus-centred detector a detector according to an embodiment of the invention may have to be built from a number of small detector modules, which themselves may have a plane surface. These modules may have to be tiled to approximate one of the above-described shapes with the help of a suitable frame. The frame may also bear the collimator, which in all cases has to be directed towards the focus. In contrast to the focus-centred detector geometry not all collimator lamellae are perpendicular to the detector shape.

The software performing the reconstruction of the measured data may be adapted to the detector geometry.

For all detector shapes according to embodiments of the invention, the design direction perpendicular to the fan plane may be independent of the fan angle as in the focus-centred geometry.

It should be noted, that the reconstruction software may have to be adapted to changes of the scatter angles and measured intensities compared to the focus-centred geometry.

FIG. 14 depicts an embodiment comprising a data processing device 400 for executing an embodiment of a method in accordance with the invention. The data processing device 400 depicted in FIG. 14 comprises a central processing unit (CPU) or image processor 401 connected to a memory 402 for storing an image depicting an object of interest, such as a patient or an item of baggage. The data processor 401 may be connected to a plurality of input/output network or diagnosis devices, such as a CT scanner. The data processor 401 may furthermore be connected to a display device 403, for example, a computer monitor, for displaying information or an image computed or adapted in the data processor 401. An operator or user may interact with the data processor 401 via a keyboard 404 and/or other output devices, which are not depicted in FIG. 14.

Furthermore, via the bus system 405, it may also be possible to connect the image processing and control processor 401 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

Embodiments of the invention may be sold as a software option to CSCT scanner console, imaging workstations or PACS workstations.

The CSCT detectors described above may lead to a better resolution of the scatter angle and consequently to an improved resolution of the scatter properties, i.e. the resulting rayleigh scattering form factors may have an improved wave-vector-transfer-resolution. Moreover, the time necessary for the reconstruction may be lowered since one step in the algorithm, the projection of the measured data onto a plane virtual detector, is bypassed.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A coherent scatter computed tomography apparatus for examination of an object of interest, comprising:
an electromagnetic radiation source for emitting electromagnetic radiation to the object of interest from a focal spot; and
a scatter detector including a first detector element arranged at a first distance from the focal spot for detecting first electromagnetic scatter radiation from the object of interest, and a second detector element arranged at a second distance from the focal spot for detecting second electromagnetic scatter radiation from the object of interest;
wherein a first length of the first distance projected onto a fan plane is different from a second length of the second distance projected onto the fan plane.

2. The apparatus of claim 1, wherein
a detector unit includes a first detector sub-unit unit and a second detector sub-unit;
wherein the first detector element is part of the first detector sub-unit;
wherein the second detector element is part of the second detector sub-unit; and
wherein the first and the second detector sub-units are focus centred.

3. The apparatus of claim 2,
wherein first and the second detector sub-units are separated from each other.

4. The apparatus of claim 2,
wherein the first detector element and the second detector element have the same size.

5. The apparatus of claim 1,
wherein the first detector element is part of the first detector sub-unit;
wherein the second detector element is part of the second detector sub-unit;
wherein the first detector sub-unit is focus centred and has a first radius of curvature;
wherein the second detector sub-unit has a second radius of curvature; and
wherein the first radius of curvature is bigger than the second radius of curvature.

6. The apparatus of claim 5,
wherein the first radius of curvature is twice the size of the second radius of curvature.

7. The apparatus of claim 1,
wherein the first detector element and the second detector element are part of the detector unit; and
wherein the detector unit has a limacon shaped cross section with respect to the fan plane.

8. The apparatus of claim 1,
wherein the first detector element and the second detector element are part of the detector unit; and
wherein the cross section of the detector unit with respect to the fan plane corresponds to a circular arc with a centre different to the focal spot.

9. The apparatus of claim 1,
wherein the detector unit comprises a first scatter detector and a transmission detector both having the same cross-sectional shape with respect to the fan plane.

10. The apparatus of claim 1,
wherein the detector unit further comprises a second scatter detector;
wherein the first scatter detector is arranged above the fan plane;
wherein the second scatter detector is arranged below the fan plane; and
wherein the transmission detector is arranged between the first and second scatter detectors in the fan plane.

11. The apparatus of claim 1,
wherein the detector unit covers only one half of the fan angle range.

12. The apparatus of claim 1, further comprising a third detector sub-unit;
wherein the first detector sub-unit is arranged between the second detector sub-unit and the third detector sub-unit.

13. The apparatus of claim 1, further comprising:
a reconstruction unit for reconstructing an image of the object of interest on the basis of the detected first and second electromagnetic radiation.

14. The apparatus of claim 1, configured as one of the group consisting of a baggage inspection apparatus, a medical application apparatus, a material testing apparatus and a material science analysis apparatus.

15. The apparatus of claim 1, further comprising:
a collimator arranged between the electromagnetic radiation source and the detecting elements; the collimator collimating an electromagnetic radiation beam emitted by the electromagnetic radiation source to form a fan-beam.

16. (canceled)

17. (canceled)

18. A method for examining an object of interest, comprising:
emitting, by a radiation source (104), electromagnetic radiation to the object of interest, the emitted radiation having a focal spot;
detecting, by a first detector element arranged at a first distance from the focal spot, first electromagnetic radiation from the object of interest; and
detecting, by a second detector element arranged at a second distance from the focal spot, second electromagnetic radiation from the object of interest;
wherein a first length of the first distance projected onto a fan plane is different from a second length of the second distance projected onto the fan plane.

19. A computer-readable medium having an embedded computer program for examining an object of interest, the computer program when executed carries out the acts comprising:
emitting, by a radiation source, electromagnetic radiation to the object of interest, the emitted radiation having a focal spot;
detecting, by a first detector element arranged at a first distance from the focal spot, first electromagnetic radiation from the object of interest; and
detecting, by a second detector element arranged at a second distance from the focal spot, second electromagnetic radiation from the object of interest;
wherein a first length of the first distance projected onto a fan plane is different from a second length of the second distance projected onto the fan plane.

20. (canceled)
